(19) United States
(12) Patent Application Publication
(10) Pub. No.: US 2025/0244605 A1
(43) Pub. Date: Jul. 31, 2025

(54) ROTATING REPLACEMENT LENS STRUCTURE FOR SPECTACLES

(71) Applicant: PROHERO GROUP CO., LTD., TAINAN CITY (TW)

(72) Inventor: PEN-WEI CHEN, TAINAN CITY (TW)

(21) Appl. No.: 18/422,356

(22) Filed: Jan. 25, 2024

(51) Int. Cl. G02C 1/02

(52) U.S. Cl. CPC G02C 1/02; G02C 2200/06; G02C 2200/08

(57) ABSTRACT

The invention relates to a rotating replacement lens structure for spectacles, which includes a spectacle frame, rotating component, and a spectacle lens. The spectacle frame has an inlay groove with an opening facing downwards, a front side wall and a rear side wall formed corresponding to the inlay groove, a through hole communicated with the inlay groove, and a first guide portion provided on a peripheral wall of the through hole. The rotating component has a shaft portion correspondingly inserted into the through hole and a second guide portion provided along the surface of the shaft portion. The shaft portion has a stop portion formed at the rear end portion thereof, and a rotatable force applying portion extending from the front end portion thereof. The spectacle lens has an upper edge embedded in the inlay groove correspondingly, and a locking hole arranged corresponding with a through hole.

### BACKGROUND OF THE PRESENT INVENTION

### Field of Invention

The present invention relates to a rotating replacement lens structure for spectacles and, in particular, to an innovative design that allows a spectacle lens to be quickly disassembled from and assembled onto the spectacle frame.

### Description of Related Arts

Conventional glasses often provide glasses with lenses that can be easily disassembled and assembled, allowing users to replace the lenses depending on the usage status, occasion, and when the lenses are damaged.

For example, Taiwan Pat. Pub. No. 1268384B “Eyeglasses with Lenses Changeable”. A perforation arranged in the center of the frame. An elastic engage block arranged above the nose bridge of the frame. A protruding rod protruding from the front end of the engage block. The protruding rod passes through the perforation. When the lens is assembled with the frame, a snap hole arranged in the center of the lens, and the engage block is inserted into the snap hole of the lens to fix the lens to the frame.

Although the structure of Taiwan Pat. Pub. No. 1268384B can achieve the effect of quick disassembly and assembly of the lens. However, the perforation of the frame penetrates the front surface of the frame, and the protruding rod penetrates outside the perforation, which damages the overall aesthetics of the glasses and thus affects the commercial value of the glasses.

The inventor of the present invention has developed the present invention in view of the shortcomings of the above-mentioned existing previous cases in actual implementation and use.

### SUMMARY OF THE PRESENT INVENTION

The main purpose and effect of the rotating replacement lens structure for spectacles of the present invention is to allow the wearer to change the lenses by himself or herself at any time, and the lens replacement is extremely convenient and fast. At the same time, the lens replacement structure will not damage the integrity of the spectacle from a perspective that a third party can view.

The above-mentioned purpose of the present invention is achieved by the following technologies:

A rotating replacement lens structure for spectacles, includes:
a spectacle frame, having an inlay groove with an opening facing downwards, a front side wall and a rear side wall formed corresponding to the inlay groove by the arrangement of the inlay groove, a through hole on the rear side wall that passes through the thickness of the rear side wall so that the through hole is communicated with the inlay groove, and a first guide portion provided on a peripheral wall of the through hole;
a rotating component, capable of rotating along an axis of the through hole, wherein the rotating component has a shaft portion correspondingly inserted into the through hole, a second guide portion provided on an outer periphery of the shaft portion, wherein the second guide portion and the first guide portion are correspondingly spirally engaged, wherein the shaft portion has a rear end portion and a front end portion opposite to each other, and a rotatable force applying portion arranged at the front end portion; and
a spectacle lens, having an upper edge embedded in the inlay groove of the spectacle frame correspondingly, and having a locking hole arranged corresponding with a through hole,
wherein when the upper edge of the spectacle lens is embedded into the inlay groove, rotate the rotatable force applying portion in a clockwise or counterclockwise direction to make the rear end portion of the rotating component rotate to enter or leave the locking hole of the spectacle lens according to the engagement between the first guide portion and the second guide portion.

The rotating replacement lens structure for spectacles as mentioned above, the rotatable force applying portion protrudes and extends radially from the front end portion to one side, wherein the rotatable force applying portion has a force application convex body disposed on a surface thereof away from the shaft portion.

The rotating replacement lens structure for spectacles as mentioned above, the spectacle frame includes a positioning slot provided on the surface of the rear side wall, away from the inlay groove, and adjacent to the through hole, wherein the rotatable force applying portion includes a positioning protrusion corresponding to the positioning slot and provided on the rotatable force applying portion of the rotating component, wherein when the positioning protrusion correspondingly enters the positioning slot and is engaged with the positioning slot, the rotating component is positioned.

The rotating replacement lens structure for spectacles as mentioned above, the rotatable force applying portion extends radially outward from the outer periphery of the front end portion, and the diameter of the rotatable force applying portion is larger than the diameter of the front end portion, wherein the rotatable force applying portion has a convex pattern arranged on a periphery wall surface thereof.

The rotating replacement lens structure for spectacles as mentioned above, the spectacle frame has a recessed area provided on the surface of the rear side wall facing the human face, the through hole is located in the recessed area, and the recessed area accommodates the rotatable force applying portion.

The rotating replacement lens structure for spectacles as mentioned above, the spectacle frame has a downward-opening notch disposed in the recessed area.

### BRIEF DESCRIPTION OF THE DRAWINGS

FIG. 1 illustrates an exploded view of a spectacle frame, a rotating component and a spectacle lens in a first embodiment of the rotating replacement lens structure for spectacles of the present invention.

FIG. 2 illustrates an enlarged and exploded view of the spectacle frame and the rotating component in the first embodiment of the rotating replacement lens structure for spectacles according to the present invention.

FIG. 3 illustrates a perspective view of the first embodiment of the rotating replacement lens structure for spectacles of the present invention, in which the rotating component is assembled on the spectacle frame but the upper edge of the spectacle lens has not yet been inserted into the inlay groove of the spectacle frame.

FIG. 4 illustrates another perspective view of the first embodiment of the rotating replacement lens structure for spectacles of the present invention, in which the rotating component is assembled on the spectacle frame but the upper edge of the spectacle lens has not yet been inserted into the inlay groove of the spectacle frame.

FIG. 5 illustrates the side sectional view of the first embodiment of the rotating replacement lens structure for spectacles of the present invention, in which the rotating component is assembled on the spectacle frame but the upper edge of the spectacle lens has not yet been inserted into the inlay groove of the spectacle frame.

FIG. 6 illustrates the side sectional view of the first embodiment of the rotating replacement lens structure for spectacles of the present invention after the spectacle frame, the rotating component, and the spectacle lens are assembled and the rotating component is not locked.

FIG. 7 illustrates a perspective view of the first embodiment of the rotating replacement lens structure for spectacles of the present invention after the spectacle frame, the rotating component, and the spectacle lens are assembled and the rotating component is in a locked state.

FIG. 8 illustrates a side sectional view of the first embodiment of the rotating replacement lens structure for spectacles of the present invention after the spectacle frame, the rotating component, and the spectacle lens are assembled and the rotating component is in a locked state.

FIG. 9 illustrates a top sectional view of the first embodiment of the rotating replacement lens structure for spectacles of the present invention after the spectacle frame, the rotating component, and the spectacle lens are assembled and the rotating component is in a locked state.

FIG. 10 illustrates an exploded view of a spectacle frame, a rotating component and a spectacle lens in a second embodiment of the rotating replacement lens structure for spectacles of the present invention.

FIG. 11 illustrates a perspective view of the second embodiment of the rotating replacement lens structure for spectacles of the present invention, in which the rotating component is assembled on the spectacle frame but the upper edge of the spectacle lens has not yet been inserted into the inlay groove of the spectacle frame.

FIG. 12 illustrates the side sectional view of the second embodiment of the rotating replacement lens structure for spectacles of the present invention, in which the rotating component is assembled on the spectacle frame but the upper edge of the spectacle lens has not yet been inserted into the inlay groove of the spectacle frame.

FIG. 13 illustrates a perspective view of the second embodiment of the rotating replacement lens structure for spectacles of the present invention, after the spectacle frame, the rotating component, and the spectacle lens are assembled and the rotating component is not locked.

FIG. 14 illustrates the side sectional view of the second embodiment of the rotating replacement lens structure for spectacles of the present invention after the spectacle frame, the rotating component, and the spectacle lens are assembled and the rotating component is not locked.

FIG. 15 illustrates a perspective view of the second embodiment of the rotating replacement lens structure for spectacles of the present invention after the spectacle frame, the rotating component, and the spectacle lens are assembled and the rotating component is in a locked state.

FIG. 16 illustrates a side sectional view of the second embodiment of the rotating replacement lens structure for spectacles of the present invention after the spectacle frame, the rotating component, and the spectacle lens are assembled and the rotating component is in a locked state.

### DETAILED DESCRIPTION OF THE PREFERRED EMBODIMENT

In order to have a more complete and clear disclosure of the technical content, the purpose of invention and the effect achieved by the present invention, it is explained in detail below, and refer to the disclosed drawings and drawing numbers together.

First, in this article, the terms “forward,” “front side,” etc. are defined as the direction indicated by the arrow—X shown on each view in the figure. The terms “backward,” “rear side,” etc. are defined as the direction indicated by the arrow-X shown on each view in the figure. The terms “upper,” “top side,” etc. are defined as the direction indicated by the arrow Z shown on each view in the figure. The terms “lower,” “bottom side,” etc. are defined as the direction indicated by the arrow-Z shown on each view in the figure.

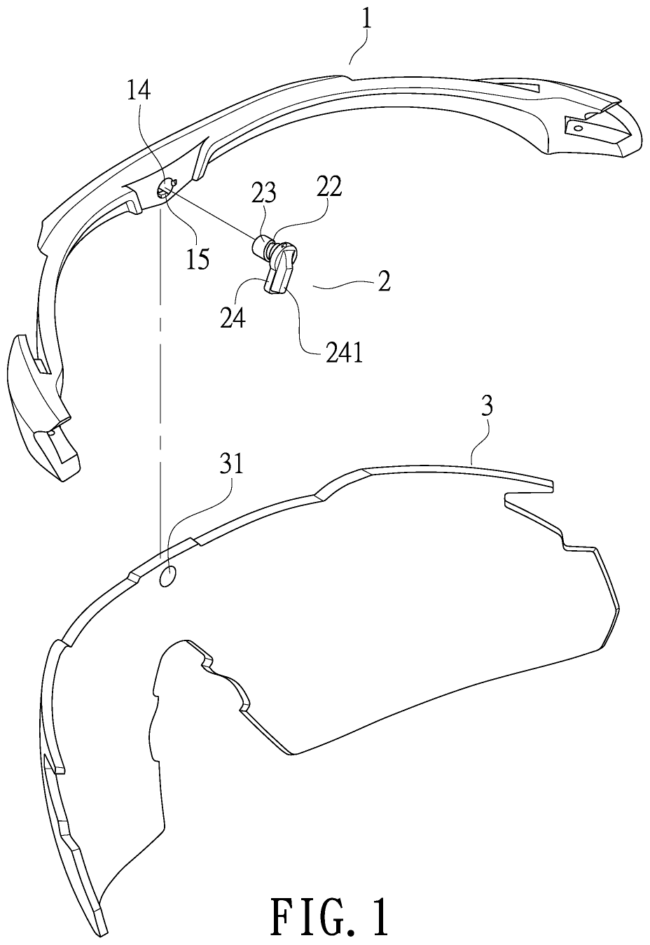

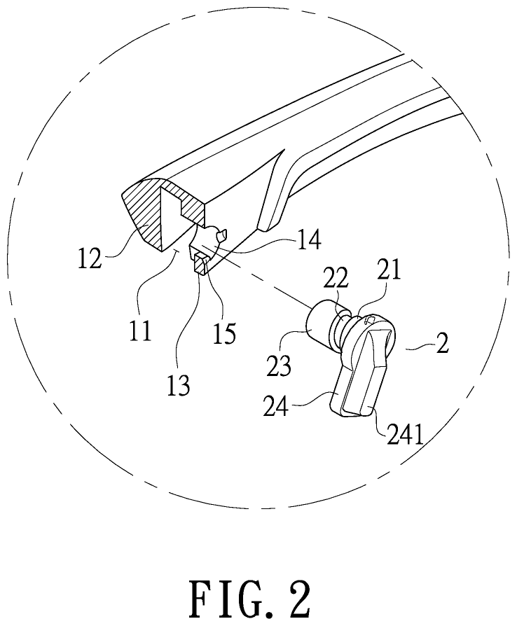

Referring to FIGS. 1 and 2, wherein FIG. 1 shows an exploded view of a spectacle frame, a rotating component, and a spectacle lens of a first embodiment of the spectacle lens replacement structure of the present invention; FIG. 2 shows an enlarged and exploded view of the spectacle frame and the rotating component of the first embodiment of the spectacle lens replacement structure of the present invention.

The first embodiment of the spectacle lens replacement structure of the present invention includes a spectacle frame 1, a rotating component 2, and a spectacle lens 3, wherein
the spectacle frame 1 has an inlay groove 11 provided thereof, wherein an opening of the inlay groove 11 faces downward, wherein due to the arrangement of the inlay groove 11, the frame 1 has a front side wall 12 and a rear side wall 13 formed at the front and rear positions corresponding to the inlay groove 11, in other words, the front side wall 12 and the rear side wall 13 define the width of the inlay groove 11, and the width is relatively suitable for the thickness of an upper edge of the spectacle lens 3, allowing the upper edge of the spectacle lens 3 to be embedded in the inlay groove 11, in addition, the spectacle frame 1 has a through hole 14 on the rear side wall 13 that passes through the thickness of the rear side wall 13 so that the through hole 14 is communicated with the inlay groove 11, and a first guide portion 15 provided on a peripheral wall of the through hole 14;
the rotating component 2 includes a shaft portion 21, which is correspondingly inserted into the through hole 14 of the spectacle frame 1, wherein the shaft portion 21 has a rear end portion and a front end portion opposite to each other, a second guide portion 22 provided along the surface of the shaft portion 21 between the rear end portion and the front end portion of the shaft portion 21, wherein the second guide portion 22 is for corresponding accommodation of the first guide portion 15 on the spectacle frame 1, a stop portion 23 formed at the rear end portion of the shaft portion 21, and a rotatable force applying portion 24 extending radially on one side at the front end portion of the shaft portion 21; and
the spectacle lens 3 has an upper edge embedded in the inlay groove 11 of the spectacle frame 1 and a locking hole 31 corresponding to the through hole 14 on the rear side wall 13 of the spectacle frame 1.

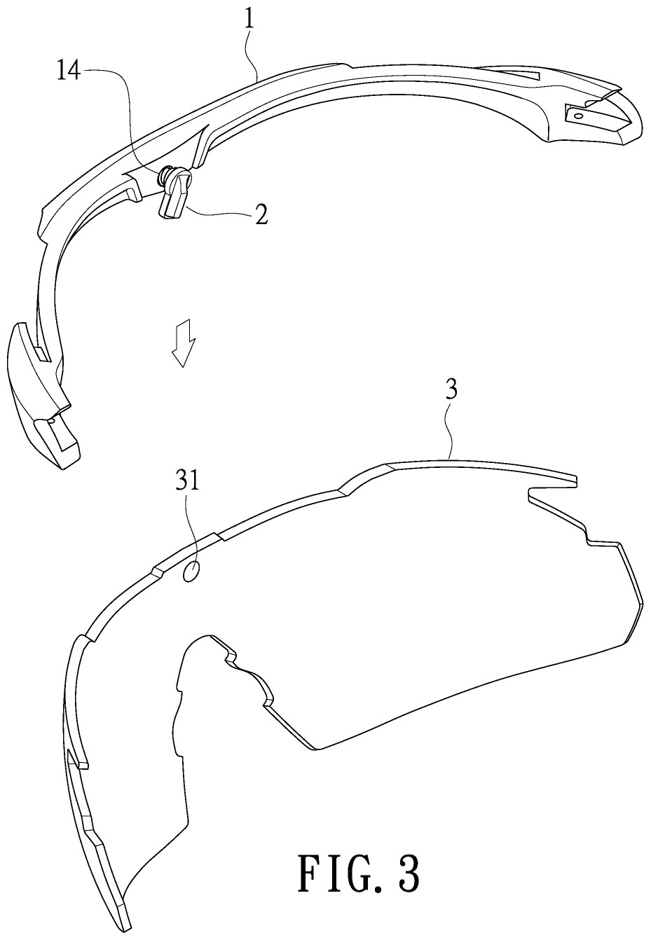

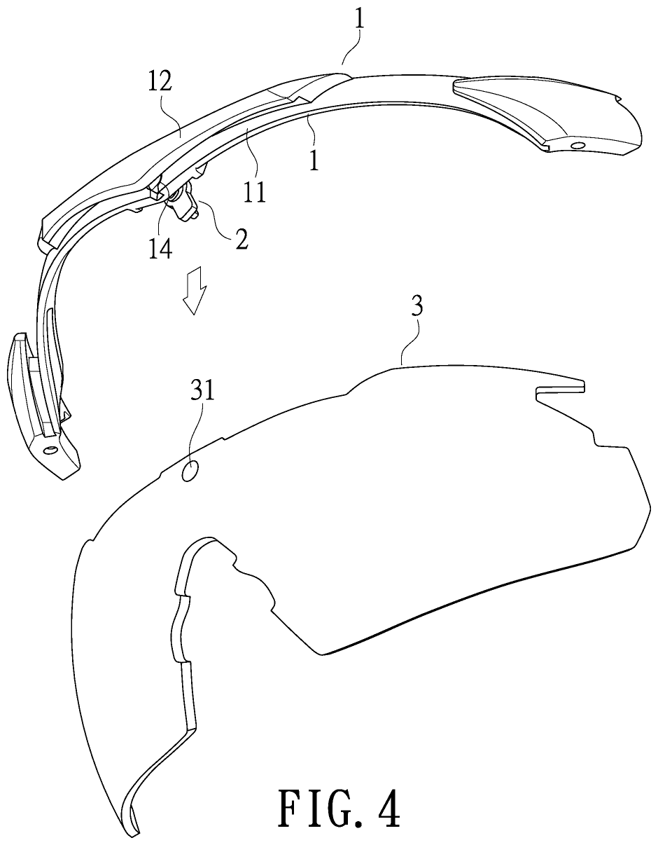

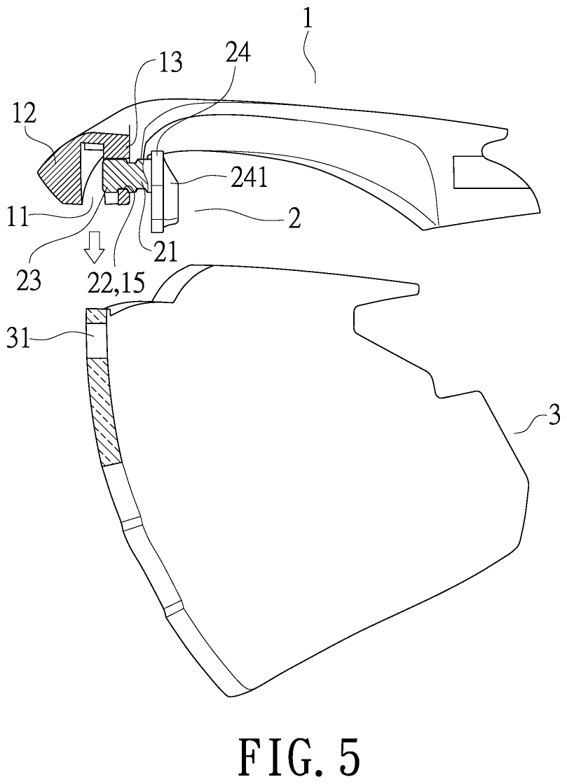

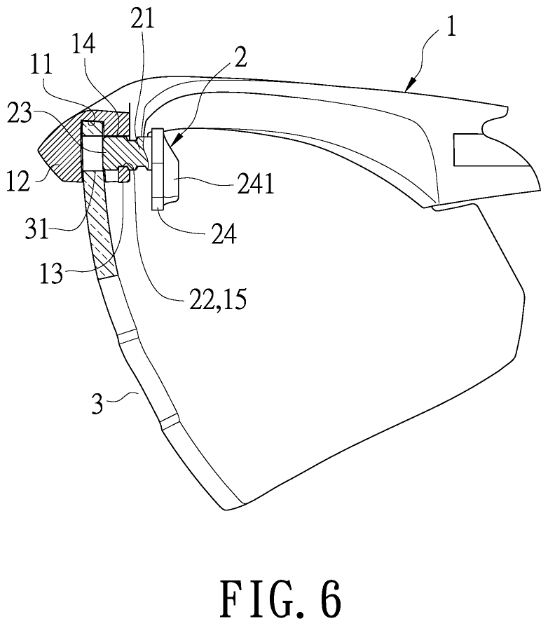

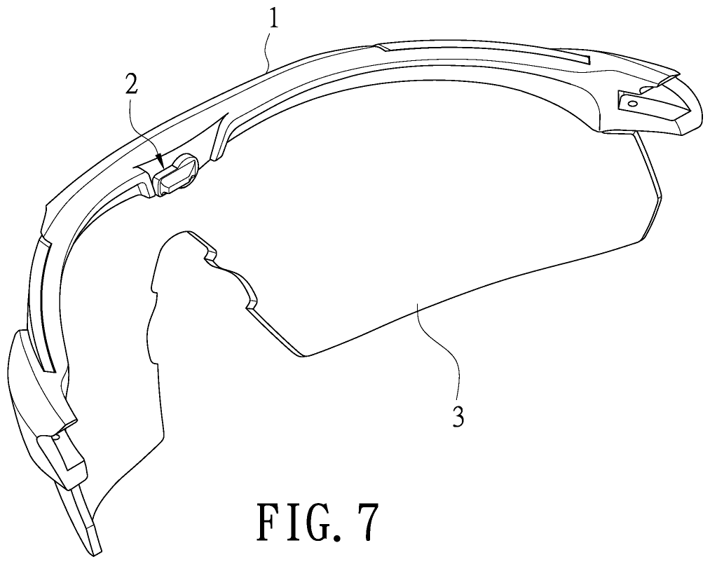

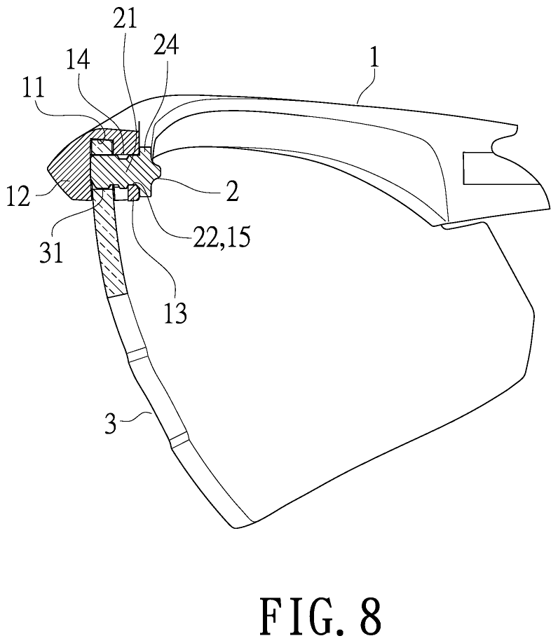

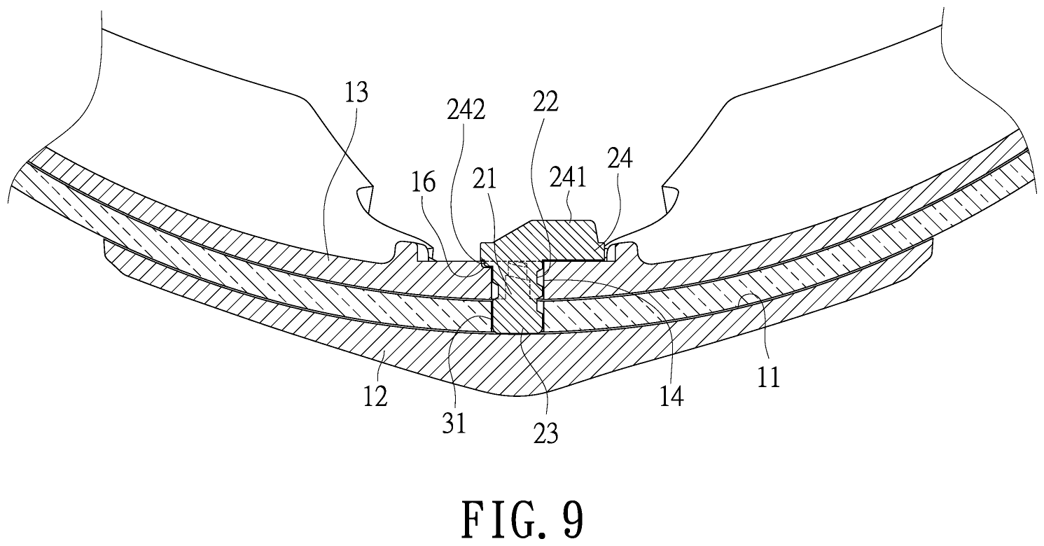

Referring to FIGS. 3 to 9. FIGS. 3 to 5 illustrate the state in which the rotating component 2 is assembled on the spectacle frame 1 but the upper edge of the spectacle lens 3 is not yet inserted into the inlay groove 11 of the spectacle frame 1; FIG. 6 illustrates the state in which the upper edge of the spectacle lens 3 is inserted into the inlay groove 11 of the spectacle frame 1 but the rotating component 2 is not yet locked; FIGS. 7 to 9 illustrate that the upper edge of the spectacle lens 3 is inserted into the inlay groove 11 of the spectacle frame 1 and the rotating component 2 is in a locked state.

First, the stop portion 23 at the rear end portion of the rotating component 2 penetrates into the through hole 14 of the spectacle frame 1, and the first guide portion 15 on the peripheral wall of the through hole 14 is correspondingly engaged with the second guide portion 22 of the rotating component 2. Therefore, when the rotating component 2 is rotated clockwise or counterclockwise, the shaft portion 21 of the rotating component 2 can move forward or backward along the axial direction of the through hole 14 through the cooperation and guidance of the first guide portion 15 and the second guide portion 22.

When the upper edge of the spectacle lens 3 is inserted into the inlay groove 11 of the spectacle frame 1, the locking hole 31 on the spectacle lens 3 just corresponds to the through hole 14 on the rear side wall 13 of the spectacle frame 1. Therefore, when force is applied from the rotatable force applying portion 24 of the rotating component 2 to rotate the rotating component 2 in the same direction as the direction of the hour hand rotation (i.e., clockwise), the rotating component 2 is guided correspondingly by the second guide portion 22 and the first guide portion 15, so that the shaft portion 21 of the rotating component 2 moves forward along the axial direction of the through hole 14, and then when the stop portion 23 of the rotating component 2 enters the locking hole 31 of the spectacle lens 3, the spectacle lens 3 can be fixed to the spectacle frame 1.

When force is applied from the rotatable force applying portion 24 of the rotating component 2 to rotate the rotating component 2 in the opposite direction as the direction of the hour hand rotation (i.e., counterclockwise), the rotating component 2 is guided correspondingly by the second guide portion 22 and the first guide portion 15, so that the shaft portion 21 of the rotating component 2 moves backward along the axial direction of the through hole 14, and then when the stop portion 23 of the rotating component 2 is separated from the locking hole 31 of the spectacle lens 3, the spectacle lens 3 can be detached from the spectacle frame 1.

In a preferred embodiment of the first embodiment of the rotating replacement lens structure for spectacles of the present invention, the rotatable force applying portion 24 has a force application convex body 241 disposed on a surface thereof away from the shaft portion 21 to facilitate the application of force to rotate the rotating component 2.

In a preferred embodiment of the first embodiment of the rotating replacement lens structure for spectacles of the present invention, wherein the spectacle frame 1 includes a positioning slot 16 provided on the surface of the rear side wall 13 of the spectacle frame 1, away from the inlay groove 11, and adjacent to the through hole 14, wherein the rotatable force applying portion 24 includes a positioning protrusion 242 corresponding to the positioning slot 16 and provided on the rotatable force applying portion 24 of the rotating component 2. When the positioning protrusion 242 correspondingly enters the positioning slot 16 and is engaged with the positioning slot 16, the rotating component 2 can be positioned in a state of locking the spectacle frame 1 and the spectacle lens 3.

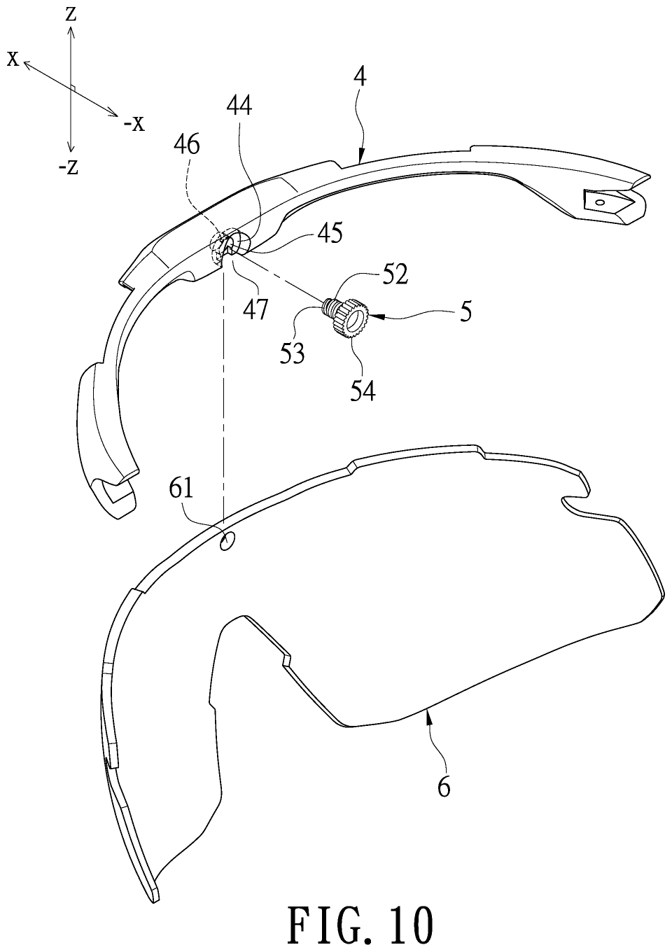

Referring to FIGS. 10 to 16, a second embodiment of the rotating replacement lens structure for spectacles of the present invention is illustrated.

Referring to FIGS. 10 to 12, the second embodiment of the rotating replacement lens structure for spectacles of the present invention includes a spectacle frame 4, a rotating component 5, and a spectacle lens 6, wherein
the spectacle frame 4 has an inlay groove 41 provided thereof, wherein an opening of the inlay groove 41 faces downward, wherein due to the arrangement of the inlay groove 41, the spectacle frame 4 has a front side wall 42 and rear side wall 43 formed at the front and rear positions corresponding to the inlay groove 41, in other words, the front side wall 42 and the rear side wall 43 define the width of the inlay groove 41, and the width is relatively suitable for the thickness of an upper edge of the spectacle lens 6, allowing the upper edge of the spectacle lens 6 to be embedded in the inlay groove 41, in addition, the spectacle frame 4 has a recessed area 44 located on the surface of the rear side wall 43 facing the human face, a through hole 45 provided in the recessed area 44 that penetrates the thickness of the rear side wall 43 so that the through hole 45 is communicated with the inlay groove 41, and a first guide portion 46 formed on the peripheral wall of the through hole 45;
the rotating component 5 includes a shaft portion 51, which is correspondingly inserted into the through hole 45 of the spectacle frame 4, wherein the shaft portion 51 has a rear end portion and a front end portion opposite to each other, a second guide portion 52 provided along the surface of the shaft portion 51 between the rear end portion and the front end portion of the shaft portion 51, wherein the second guide part 52 is correspondingly engaged with the first guide portion 46 on the spectacle frame 4, a stop portion 53 formed at the rear end portion of the shaft portion 51, and a rotatable force applying portion 54 at the front end portion of the shaft portion 51, wherein the rotatable force applying portion 54 extends radially outward from the outer periphery of the front end portion, and the diameter of the rotatable force applying portion 54 is larger than the diameter of the front end portion, wherein when the rotatable force applying portion 54 of the rotating component 5 is rotated to the locked position, the rotatable force applying portion 54 will sink relatively into the recessed area 44 or be flush with the surface of the rear side wall 43 of the spectacle frame 4 facing the human face; and
the spectacle lens 6 has an upper edge embedded in the inlay groove 41 of the spectacle frame 4 and a locking hole 61 corresponding to the through hole 45 on the rear side wall 43 of the spectacle frame 4.

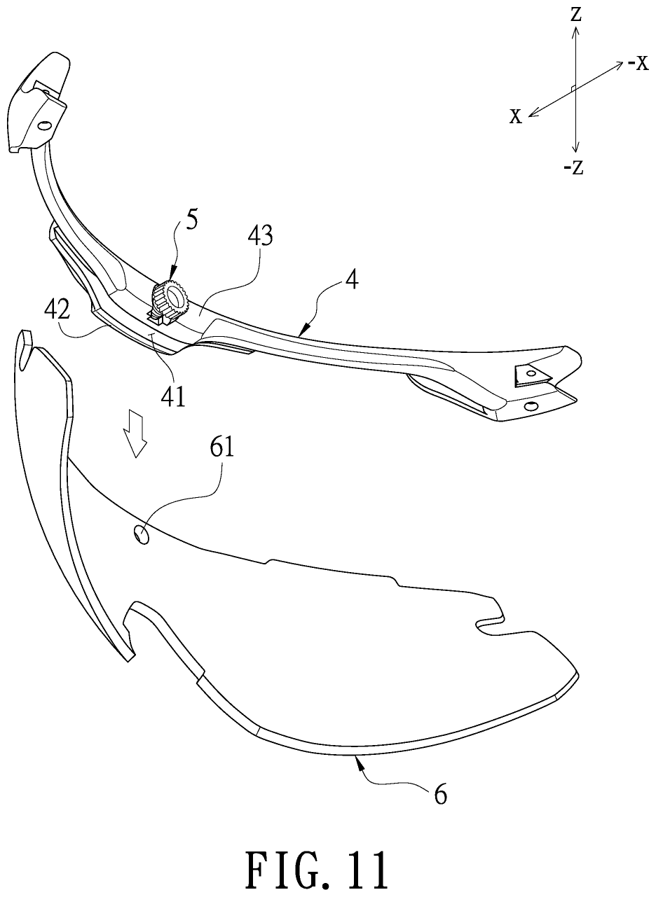

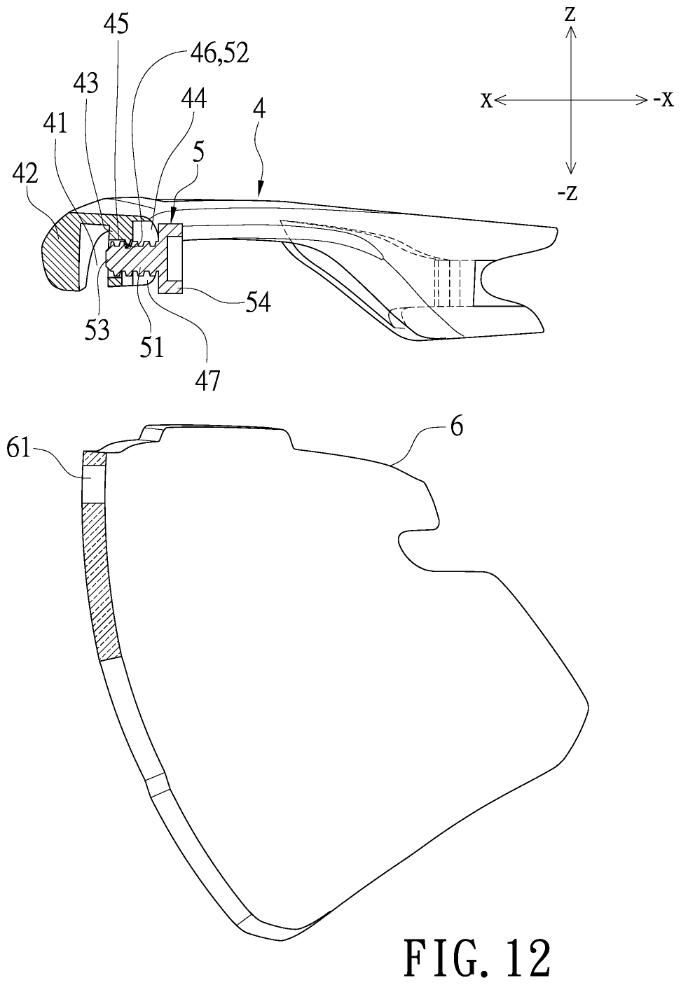

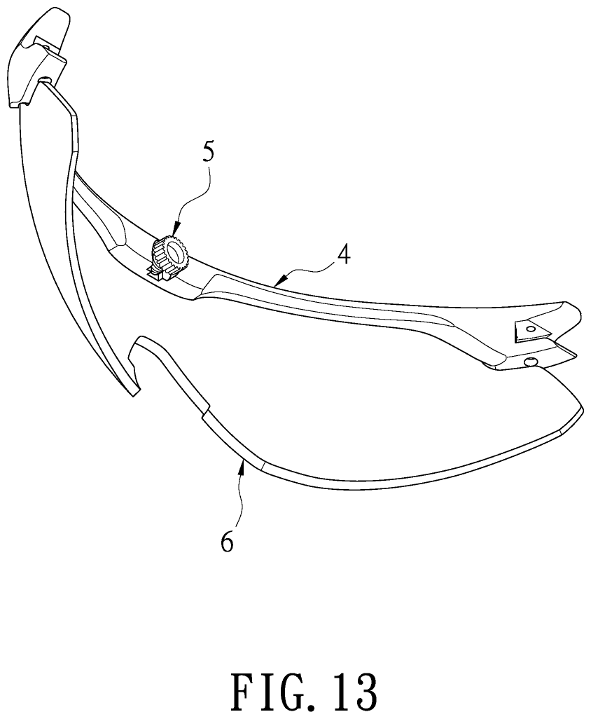

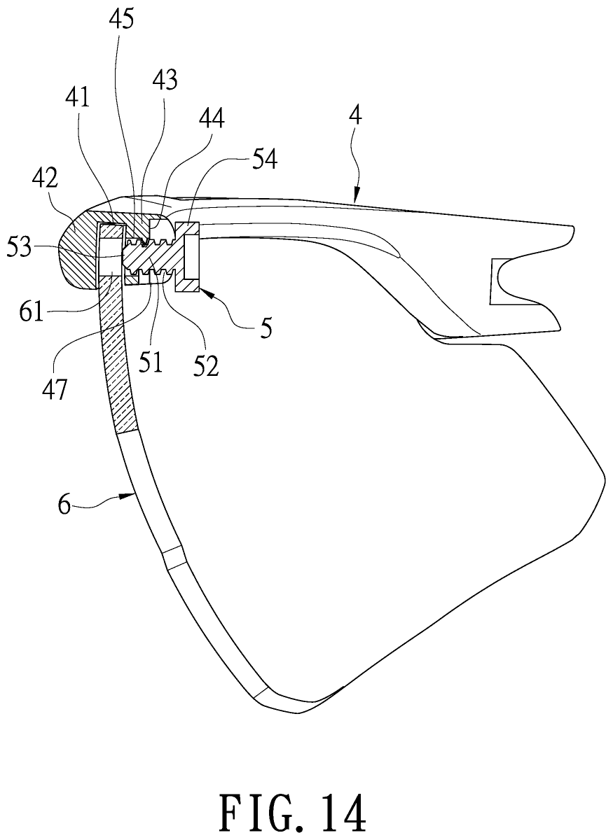

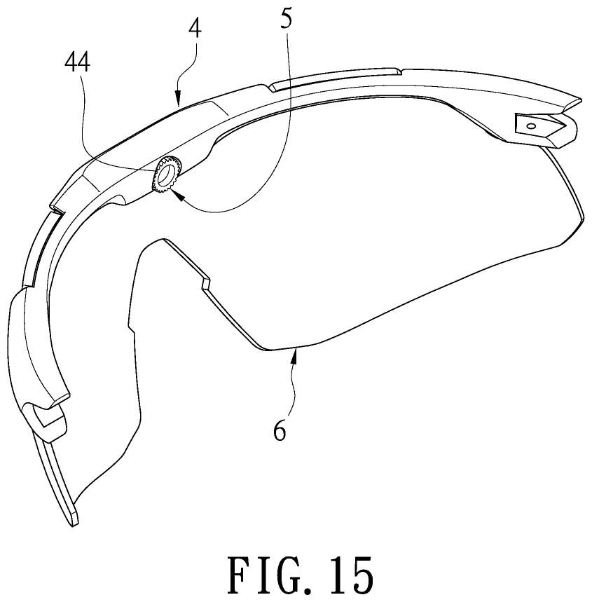

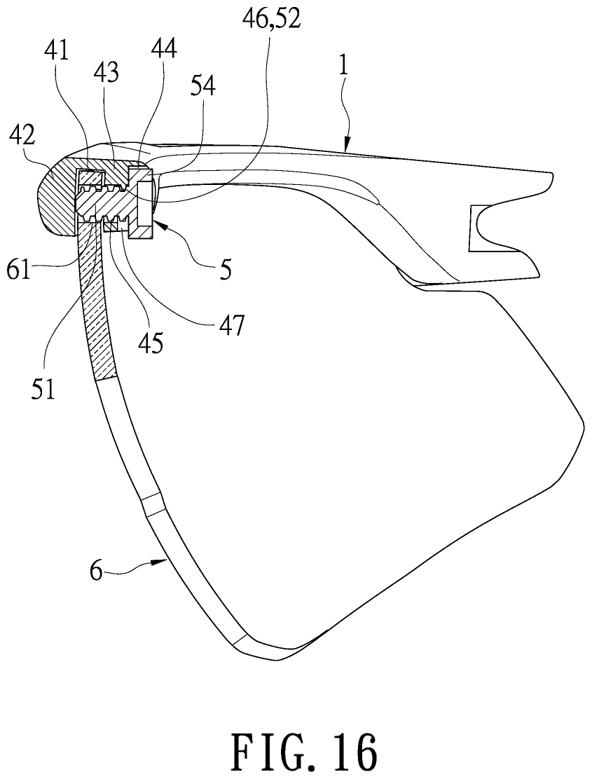

Referring to FIGS. 11 to 16. FIGS. 11 to 12 illustrate the state in which the rotating component 5 is assembled on the spectacle frame 4 but the upper edge of the spectacle lens 6 is not yet inserted into the inlay groove 41 of the spectacle frame 4; FIGS. 13 and 14 illustrates the state in which the upper edge of the spectacle lens 6 is inserted into the inlay groove 41 of the spectacle frame 4 but the rotating component 5 is not yet locked; FIGS. 15 and 16 illustrate that the upper edge of the spectacle lens 6 is inserted into the inlay groove 41 of the spectacle frame 4 and the rotating component 5 is in a locked state.

First, the rotating component 5 is inserted into the through hole 45 of the spectacle frame 4 with the stop portion 53 at the rear end portion of the shaft portion 51, and the first guide portion 46 on the peripheral wall of the through hole 45 is correspondingly engaged with the second guide portion 52 of the rotating component 5, so that when the rotating component 5 is rotated in the direction in which the hour hand of the clock rotates or in the opposite direction to the rotation of the hour hand of the clock, the shaft portion 51 of the rotating component 5 can be moved forward or backward along the axial direction of the through hole 45, through the cooperative guidance of the first guide portion 46 and the second guide portion 52.

When the upper edge of the spectacle lens 6 is inserted into the inlay groove 41 of the spectacle frame 4 and is positioned, the locking hole 61 on the spectacle lens 6 just corresponds to the through hole 45 on the rear side wall 43 of the spectacle frame 4. Then, when the rotatable force applying portion 54 of the rotating component 5 is rotated to rotate the rotating component 5 in the same direction as the direction of the hour hand rotation (that is, clockwise), the shaft portion 51 of the rotating component 5 is along the axial direction of the through hole 45 go ahead, and then when the rear end portion of the shaft portion 51 of the rotating component 5 enters the locking hole 61 of the spectacle lens 6, the spectacle lens 6 can be fixed on the spectacle frame 4.

When the rotatable force applying portion 54 is rotated and the rotating component 5 is rotated in the opposite direction as the direction of the hour hand rotation (that is, counterclockwise), the rotating component 5 will retreat along the axial direction of the through hole 14. When the rear end portion of the shaft portion 51 of the rotating component 5 is separated from the locking hole 61 of the spectacle lens 6, the spectacle lens 6 can be detached from the spectacle frame 4.

In a preferred embodiment of the second embodiment structure of the screw-lock type spectacle lens replacement structure of the present invention, the rotating component 5 has a convex pattern located on a periphery wall surface of the rotatable force applying portion 54, which can increase the frictional force of the surface of the rotatable force applying portion 54, so as to facilitate the force application to rotate the rotating component 5.

In a preferred embodiment of the second embodiment structure of the screw-lock type spectacle lens replacement structure of the present invention, the spectacle frame 4 has a downward-opening notch 47 disposed in the recessed area 44 of the rear side wall 43 thereof, so that the periphery wall of the rotatable force applying portion 54 of the rotating component 5 is exposed to the bottom surface of the rear side wall 43 when corresponding to the notch 47, so as to facilitate the rotatable force applying portion 54 exposed from the notch 47 to push the rotating component 5.

What is claimed is:

1. A rotating replacement lens structure for spectacles, comprising:
a spectacle frame, having an inlay groove with an opening facing downwards, a front side wall and a rear side wall formed corresponding to the inlay groove by the arrangement of the inlay groove, a through hole on the rear side wall that passes through the thickness of the rear side wall so that the through hole is communicated with the inlay groove, and a first guide portion provided on a peripheral wall of the through hole;
a rotating component, capable of rotating along an axis of the through hole, wherein the rotating component has a shaft portion correspondingly inserted into the through hole, a second guide portion provided on an outer periphery of the shaft portion, wherein the second guide portion and the first guide portion are correspondingly spirally engaged, wherein the shaft portion has a rear end portion and a front end portion opposite to each other, and a rotatable force applying portion arranged at the front end portion; and
a spectacle lens, having an upper edge embedded in the inlay groove of the spectacle frame correspondingly, and having a locking hole arranged corresponding with a through hole,
wherein when the upper edge of the spectacle lens is embedded into the inlay groove, rotate the rotatable force applying portion in a clockwise or counterclockwise direction to make the rear end portion of the rotating component rotate to enter or leave the locking hole of the spectacle lens according to the engagement between the first guide portion and the second guide portion.

2. The rotating replacement lens structure for spectacles as claimed in claim 1, wherein the rotatable force applying portion protrudes and extends radially from the front end portion to one side, wherein the rotatable force applying portion has a force application convex body disposed on a surface thereof away from the shaft portion.

3. The rotating replacement lens structure for spectacles as claimed in claim 2, wherein the spectacle frame includes a positioning slot provided on the surface of the rear side wall, away from the inlay groove, and adjacent to the through hole, wherein the rotatable force applying portion includes a positioning protrusion corresponding to the positioning slot and provided on the rotatable force applying portion of the rotating component, wherein when the positioning protrusion correspondingly enters the positioning slot and is engaged with the positioning slot, the rotating component is positioned.

4. The rotating replacement lens structure for spectacles as claimed in claim 1, wherein the rotatable force applying portion extends radially outward from the outer periphery of the front end portion, and the diameter of the rotatable force applying portion is larger than the diameter of the front end portion, wherein the rotatable force applying portion has a convex pattern arranged on a periphery wall surface thereof.

5. The rotating replacement lens structure for spectacles as claimed in claim 3, wherein the spectacle frame has a recessed area provided on the surface of the rear side wall facing the human face, the through hole is located in the recessed area, and the recessed area accommodates the rotatable force applying portion.

6. The rotating replacement lens structure for spectacles as claimed in claim 5, wherein the spectacle frame has a downward-opening notch disposed in the recessed area.

7. The rotating replacement lens structure for spectacles as claimed in claim 2, wherein the spectacle frame has a recessed area provided on the surface of the rear side wall facing the human face, the through hole is located in the recessed area, and the recessed area accommodates the rotatable force applying portion.

8. The rotating replacement lens structure for spectacles as claimed in claim 7, wherein the spectacle frame has a downward-opening notch disposed in the recessed area.

9. The rotating replacement lens structure for spectacles as claimed in claim 1, wherein the spectacle frame has a recessed area provided on the surface of the rear side wall facing the human face, the through hole is located in the recessed area, and the recessed area accommodates the rotatable force applying portion.

10. The rotating replacement lens structure for spectacles as claimed in claim 9, wherein the spectacle frame has a downward-opening notch disposed in the recessed area.
